(19) United States
(12) Patent Application Publication
(10) Pub. No.: US 2005/0082381 A1
(43) Pub. Date: Apr. 21, 2005

(54) Swinging mechanism for lawn sprinkler

(75) Inventor: Gary Wang, Ontario, CA (US)

Correspondence Address: TROXELL LAW OFFICE PLLC, SUITE 1440, 5205 LEESBURG PIKE, FALLS CHURCH, VA, 22041, US

(73) Assignee: Aquastar Industries Inc.

(21) Appl. No.: 10/748,251

(22) Filed: Dec. 31, 2003

(30) Foreign Application Priority Data
Oct. 21, 2003 (TW) 092218692

(51) Int. Cl. B05B 5/025

(52) U.S. Cl. 239/3

(57) ABSTRACT

A swinging mechanism for a lawn sprinkler includes a sprinkling control unit with a gear-operated transmission mechanism adapted therein attached to one side of a sprinkler mount thereof. A limiting connector having a water outlet connector engaged at one side is correspondingly matched to the gear-operated transmission mechanism and a sprinkler body. A main driving wheel, an adjusting seat, and a water inlet connector are sequentially coupled at the other end of the gear-operated transmission mechanism thereof. A flow switch plate, a switch device and a retaining pole are mounted to a limiting groove of the adjusting seat thereof. The switch device, of a frame body, has resilient ribs extending centripetally at the inner side meshing with an adjusting serrated section of the retaining pole, inverted U-shaped resilient sections with stop blocks abutting against one side of protruded guide blocks of the limiting groove thereof, and indented control sections to retain both ends of the flow switch plate therein. To swing back the sprinkler body at the limiting end, the switch device is rotated at the limiting groove of the adjusting groove therein via the retaining pole coupled with the gear-operated transmission mechanism at one end, instantaneously pushing the stop blocks over to the other side of the protruded guide blocks and activating the flow switch plate to move therewith so as to precisely switch the angle of water discharge and effect the operation of the sprinkling control unit in an easy and smooth manner.

### BACKGROUND OF THE INVENTION

The present invention is related to a swinging mechanism for a lawn sprinkler, including a sprinkling control unit attached to one side of a sprinkler mount wherein the sprinkling control unit is made up of a gear-operated transmission mechanism, a limiting connector, a water inlet connector, a water outlet connector, a main driving wheel, and an adjusting seat. A flow switch plate, a switch device and a retaining pole are pivotally mounted to a limiting groove of the adjusting seat thereof; whereby, to swing back a sprinkler body at the limiting end, the switch device is rotated at the limiting groove of the adjusting groove therein via the retaining pole coupled with the gear-operated transmission mechanism at one end, instantaneously moving the flow switch plate therewith so as to precisely switch the angle of water discharge and effect an easy and smooth operation of the present invention thereof.

Please refer to FIGS. 1 to 5 inclusive. A conventional swinging mechanism for a lawn sprinkler includes a sprinkling mount 10, and a sprinkling control unit 11 having a gear-operated transmission mechanism 11 adapted therein attached to one side of the sprinkling mount 10 thereof. The sprinkling control unit 11 also has a limiting connector 112 fixed at one outer end thereof, and a water inlet connector 113 with a water control valve adapted therein joined at the other outer end thereof. The limiting connector 112 is correspondingly worked with the gear-operated transmission mechanism 111 and a sprinkler body (without shown in the diagram). The gear-operated transmission mechanism 111 is equipped with two pairs of symmetrical resilient plates 1111, 1112 protruding at one end thereof wherein one pair of the symmetrical resilient plates 1111 has a hooked flange 1111′ protruding at the outer edge thereof respectively to be fixed to an annular facet 1132′ of a sleeve hole 1131′ of a water outlet connector 113′, and the other pair of the symmetrical resilient plates 1112 has a protruding rib 1112′ disposed at the outer periphery thereon respectively to be meshed with a serrated facet 1133′ of the sleeve hole 1131′ thereof as shown in FIG. 2. The other end of the gear-operated transmission mechanism 1111 is pivotally engaged with a rotary main driving wheel 114 to which an adjusting seat 115 having water inlet holes 1151 and pressure-relief vents disposed thereon is coupled at the other side thereof A rotary device 116 with a locating member 117 joined therein is in sleeve engagement with the adjusting seat 115 thereof. The locating member 117 thereof has a pair of left and right water orifices 1171 symmetrically disposed at both upper and lower sides thereof respectively, matching to the water inlet holes 1151 of the adjusting seat 115 thereof as shown in FIG. 3. A pair of hooked springs 118 are symmetrically disposed at the left and right side of the locating member 117 thereof in linking cooperation with the rotary device 116 thereof as shown in FIG. 4.

There are some drawbacks to such conventional swinging mechanism for a lawn sprinkler. First, to swing the sprinkler body back when going to the end limited by the limiting connector 112, the rotary device 116 will rotate in the contrary direction, compressing the hooked springs 118 till rebound to the other side to switch the angle of sprinkler body thereof as shown in FIG. 4. Thus, the rotary device 116 sharing the same axis but rotated in the contrary direction is inefficient in the operation thereof. Second, when the sprinkling control unit 11 is switched in the angle of water discharge to swing the sprinkler body thereof, a gap A tends to be formed at the corresponding inner side of the adjusting seat 115 and the locating member 117 there-between as shown in FIG. 3. Thus, water coming in from the water inlet holes 1151 to flow out at the water orifices 1171 disposed at the left side thereof tends to go through the gap A and leak out through the water orifices 1171 disposed at the right side thereof, resulting in the insufficient switch of the water discharge. Third, when the sprinkling control unit 11 is switched in the angle of water discharge to swing the sprinkler body thereof, the rotary device 116 and the springs 118 are moved in the contrary direction with respect to the locating member 117 thereof, making the switch of water discharge rather complicated and inconvenient in operation.

### SUMMARY OF THE PRESENT INVENTION

It is, therefore, the primary purpose of the present invention to provide a swinging mechanism for a lawn sprinkler, including a sprinkling control unit attached to one side of a sprinkling mount wherein, via stop blocks of a switch device correspondingly worked with protruded guide blocks of an adjusting seat, a sprinkler body is easily swung back in another direction when going to an end at one side limited by a limiting connector. The switch device is rotated at a limiting groove of the adjusting seat therein, twisting resilient ribs of the switch device thereof to generate a force moving the stop blocks along the protruded guide blocks and compressing inverted U-shaped resilient sections of the switch device till the stop blocks thereof instantaneously moved over to the other side of the protruded guide blocks in abutting location, effecting an easy and simply switching operation thereof.

It is, therefore, the secondary purpose of the present invention to provide a swinging mechanism for a lawn sprinkler wherein, via a flow switch plate located at indented control sections of the switch device and limited thereby, the sprinkling control unit is precisely switched in the angle of water discharge to swing the sprinkler body thereof. The flow switch plate is activated to move via the rotated switch device, concealing a pair of previously open upper and lower water orifices for the discharge of water from another pair of upper and lower water orifices of different angle. Meanwhile, the flow switch plate is precisely abutted against the control sections of switch device by both ends, preventing the casual movement of the flow switch plate thereof for more accurate switch and control of the water discharge.

It is, therefore, the third purpose of the present invention to provide a swinging mechanism for a lawn sprinkler wherein, when the sprinkling control unit is switched in the angle of water discharge to swing the sprinkler body, the switch device and the flow switch plate, of the same axis, are rotated in the same direction, facilitating a precise switch of water discharge in an easy and smooth manner.

It is, therefore, the fourth purpose of the present invention to provide a swinging mechanism for a lawn sprinkler wherein, due to the switch device and a retaining pole separately designed but accurately located, the resilient ribs of the switch device will slip from the adjusting serrated section of the retaining pole and make the retaining pole thereof spin vainly when the sprinkler body is deliberately twisted and held to one side, effectively protecting the structure of the sprinkling control unit thereof so as to prolong its lifetime in use.

### BRIEF DESCRIPTION OF THE DRAWINGS

FIG. 1 is a cross sectional view of a conventional swinging mechanism for a lawn sprinkler in assembly.

FIG. 2 is a partially cross sectional view of a gear-operated transmission mechanism of the conventional swinging mechanism thereof joined to a water outlet connector at one end thereof.

FIG. 3 is a cross sectional diagram showing water flowing into an adjusting seat and a locating member of the conventional swinging mechanism thereof.

FIG. 4 is a cross sectional diagram of a rotary device and the locating member of the conventional swinging mechanism switched in angles in practical use.

FIG. 5 is a perspective exploded view of the present invention.

FIG. 6 is a cross sectional view of the present invention in assembly.

FIG. 7 is a cross section view of a switch device and an adjusting seat of the present invention in assembly.

FIG. 8 is a cross section diagram showing the switch device and the adjusting seat of the present invention in operation when a sprinkler body is switched in angles.

FIG. 9 is a cross sectional diagram showing the switch device and the adjusting seat of the present invention switched into position.

FIG. 10 is cross sectional diagram showing the switch device of the present invention spinning vainly relative to a retaining pole when the sprinkler body being deliberately twisted and held to one side.

FIG. 11 is a cross sectional diagram showing wing panels of a gear-operated transmission mechanism spinning vainly at a serrated facet of a sleeve hole of a water outlet connector therein.

FIG. 12 is a cross sectional view of another embodiment of the present invention.

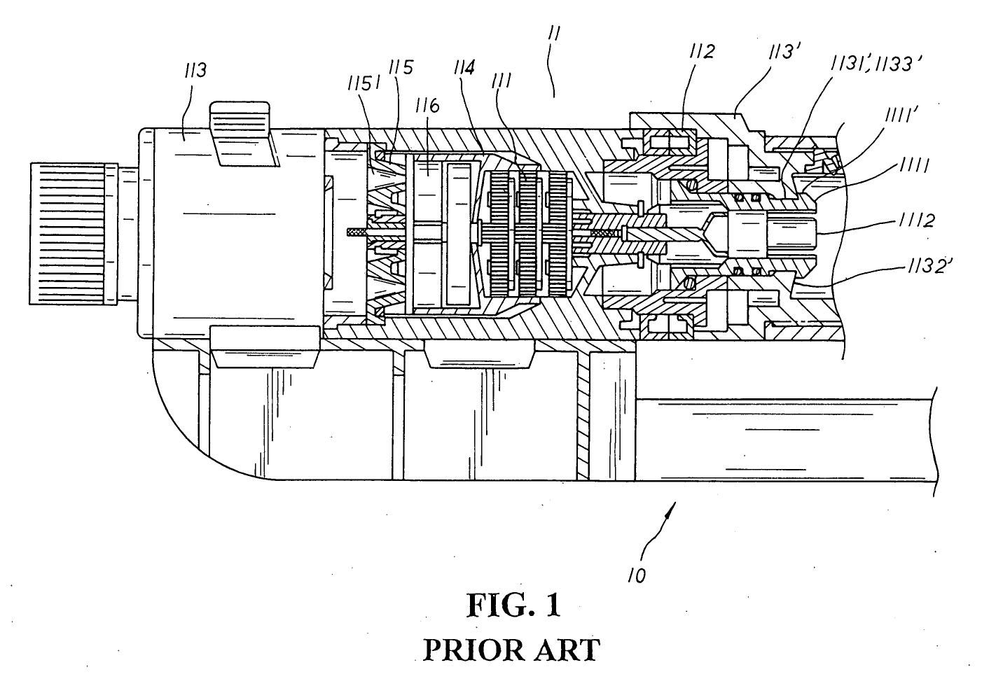

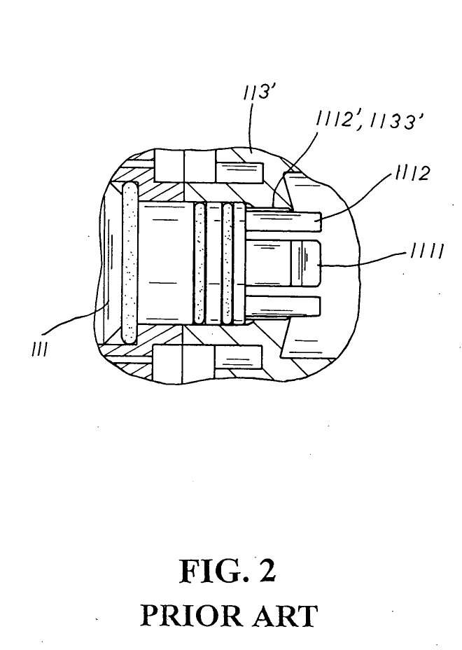

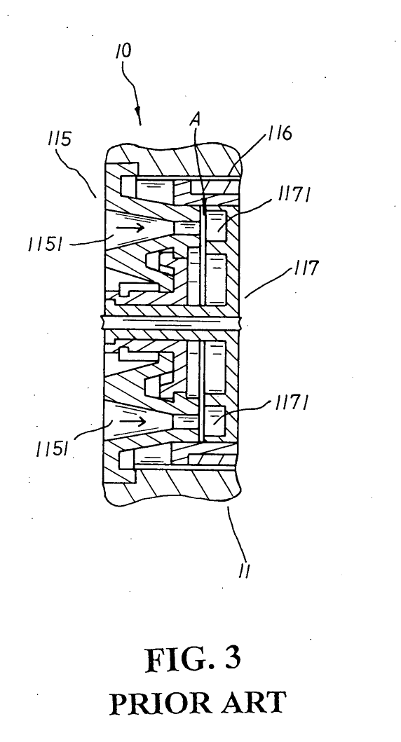

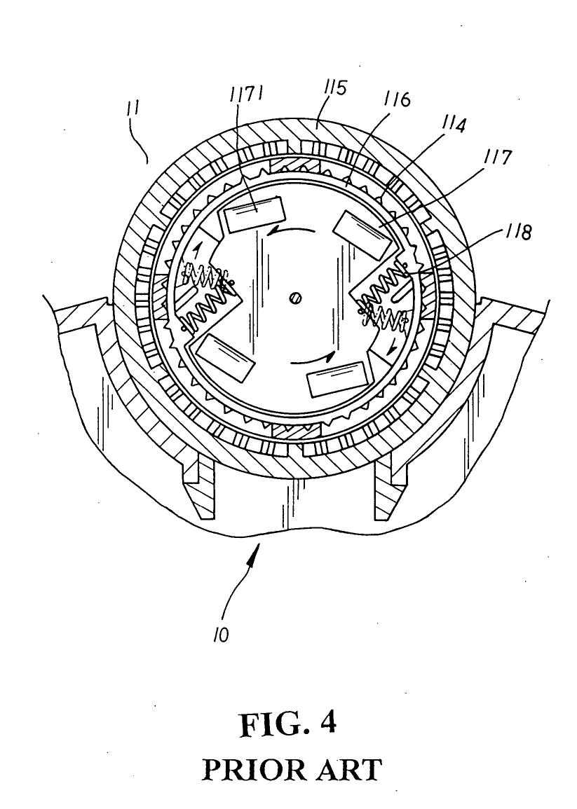

### DETAILED DESCRIPTION OF THE PREFERRED EMBODIMENTS

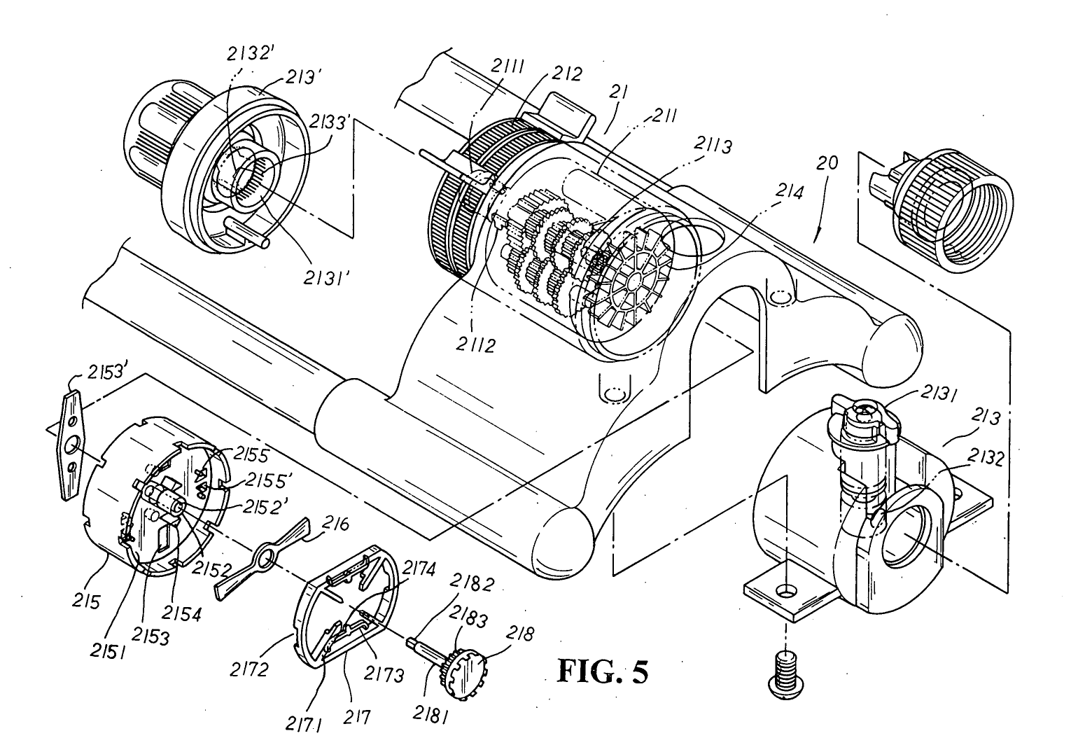

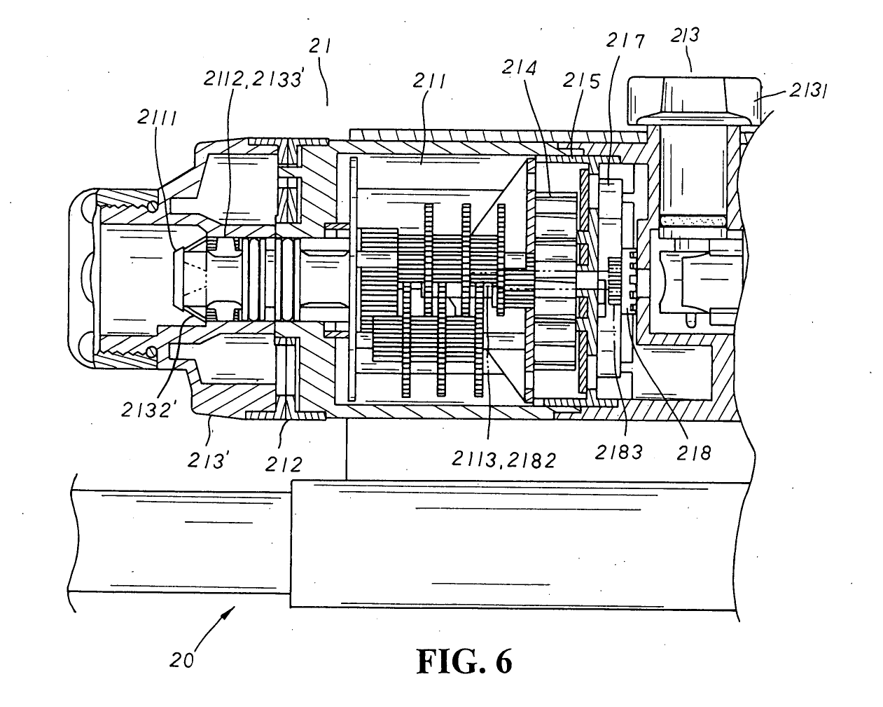

Please refer to FIGS. 5 and 6. The present invention is related to a swinging mechanism for a lawn sprinkler, including a sprinkler mount 20, and a sprinkling control unit 21 with a gear-operated transmission mechanism 211 adapted therein attached to one side of the sprinkler mount 20. The sprinkling control unit 21 also has a limiting connector 212 and a water outlet connector 213′ joined sequentially at one outer end, and an water inlet connector 213 with a water control valve 2131 adapted therein engaged at the other outer end thereof. The water control valve 2131 having a water inlet hole 2132 disposed at the inner side of the water inlet connector 213 is applied to control the amount of water discharge, and the limiting connector 212 is correspondingly matched to the gear-operated transmission mechanism 211 and a sprinkler body (without shown in the diagram). The gear-operated transmission mechanism 211 is equipped with a tapered stop flange 2111 protruding at one end thereof, and a pair of resilient wing panels 2112 symmetrically disposed at the upper and lower periphery of the one end thereof in meshing engagement with an annular serrated facet 2133′ defining a sleeve hole 2131′ of the water outlet connector 213′ therein. The sleeve hole 2131′ of the water outlet connector 213′ also has a plurality of sleeve plates 2132′ protruding at the front of the sleeve hole 2131′ thereof for the tapered stop flange 2111 thereof to be abutted against in location thereby. At the other end of the gear-operated transmission mechanism 211 is disposed a squared coupling hole 2113, and a rotary main driving wheel 214 pivotally engaged therewith to activate the gear-operated transmission mechanism 211 thereby.

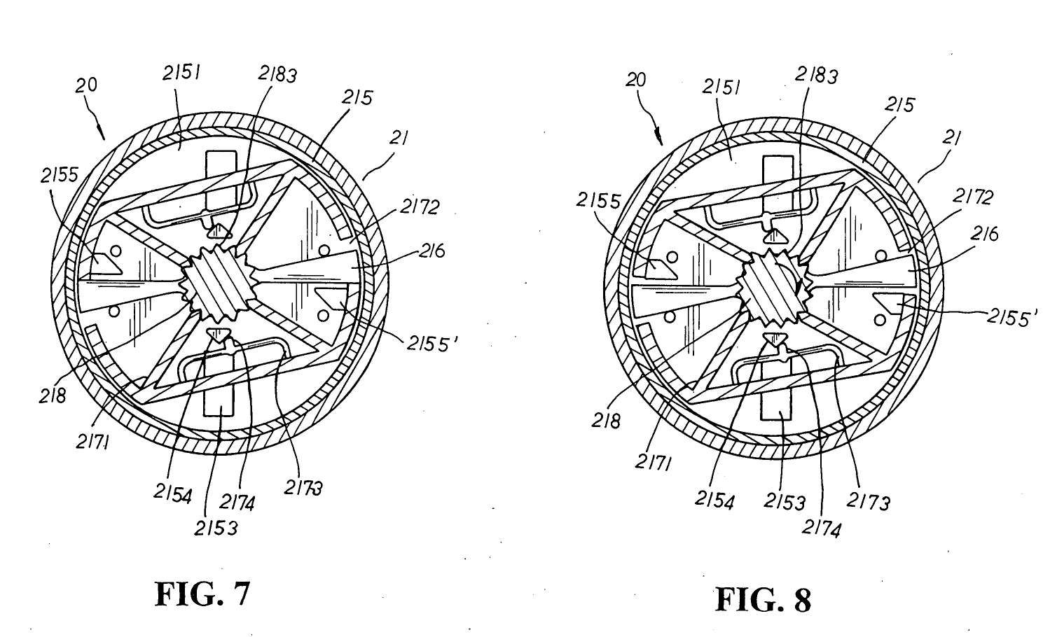

An adjusting seat 215 mounted to one side of the main driving wheel 214 is made up of a limiting groove 2151 indented at one side thereof, a coupling rod 2152 with a pivoting hole 2152′ disposed therein protruding at the center of the limiting groove 2151 thereof for a flow switch plate 216 and a retaining pole 218 to be sequentially joined thereto. Pressure-relief vents 2153 and triangular guide blocks 2154 are symmetrically preset at the upper and lower surfaces of the limiting groove 2151 around the coupling rod 2152 thereof, and two pairs of upper and lower water orifices 2155, 2155′ are symmetrically arranged at the left and right surfaces of the limiting grooves 2151 thereof around both sides of the coupling rod 2152 thereof. A pressure-relief plate 2153′ is welded to the rear side of the pressure-relief vents 2153 thereof. The retaining pole 218 is equipped with a pivoting rod 2181 having a squared coupling end 2182 to be fixedly engaged with the squared coupling hole 2113 of the gear-operated transmission mechanism 211 thereof, and an adjusting serrated section 2183 of larger diameter disposed at the other end thereof correspondingly matched to a switch device 217. The switch device 217, which is formed of a frame body, has a plurality of resilient ribs 2171 extending centripetally at the inner side thereof to be meshed with the adjusting serrated section 2183 thereof, and an indented control section 2172 cut at each arc lateral side thereof for each end of the flow switch plate 216 to be abutted against and limited thereby. The flow switch plate 216 located at the indented control sections 2172 of the switch device 217 therein is diagonally positioned into an angle to conceal alternatively an upper water orifice 2155 at one side and a lower water orifice 2155′ thereof at the other side thereof, or vice versa. The switch device 217 also includes a pair of inverted U-shaped resilient sections 2173 symmetrically disposed at the upper and lower inner side thereof, each having a stop block 2174 protruding at the central top thereof to be abutted against one side of the triangular guide block 2154 of the adjusting seat 215 thereof as shown in FIG. 7.

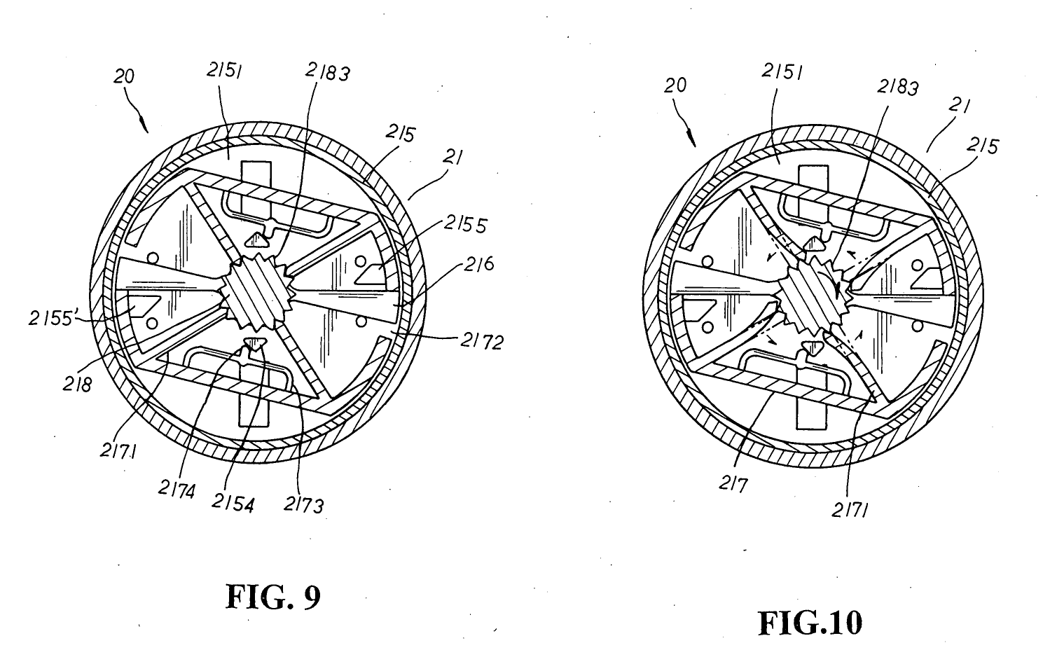

Please refer to FIGS. 8 to 10 inclusive. The current of water flowing into the water control valve 2131 of the water inlet connector 213 via the water inlet hole 2132 thereof and going out through the upper and lower water orifices 2155, 2155′ unconcealed by the flow switch plate 216 will activate the main driving wheel 214 to rotate in one direction, triggering the movement of the gear-operated transmission mechanism which in turn will actuate the sprinkler body (without shown in the diagram) to swing to one side therewith. And the sprinkler body thereof is swung to and fro within a range determined and adjusted by the limiting connector 212 thereof. To swing the sprinkler body backwards after going to the extreme at one side defined by the limiting connector 212, the gear-operated transmission mechanism 211 stopped thereby is forced to turn around by the water current kept flowing in the meantime. The gear-operated transmission mechanism 211 turned around will activate the retaining pole 218 led through the limiting groove 2151 of the adjusting seat 215 to move therewith and rotate the switch device 217 at the limiting groove 2151 therein. The resilient ribs 2171 are then twisted by torque force as shown in FIG. 8 till passing through the central line thereof to accomplish the instantaneous move of location towards the direction of the torque force. The stop blocks 2174 are pushed along the bottom side of the triangular guide blocks 2154 by the force generated and the center of the U-shaped resilient sections 2173 are evenly compressed thereby till the stop blocks 2174 are instantaneously moved over to the other side of the triangular guide blocks 2154 in abutting location thereof, resulting in the instantaneous rotation of the switch device 217 as a whole. Meanwhile, the flow switch plate 216 is pivotally rotated to one side therewith via the guidance of the indented control section 2172 thereof, precisely sealing up the previous upper and lower water orifices 2155, 2155′ as shown in FIG. 9 for revealing another pair of upper and lower water orifices 2155, 2155′. The current of water guided to come out at another angle will activate the main driving wheel 214 and the gear-operated transmission mechanism 211 as well to rotate in another direction therewith.

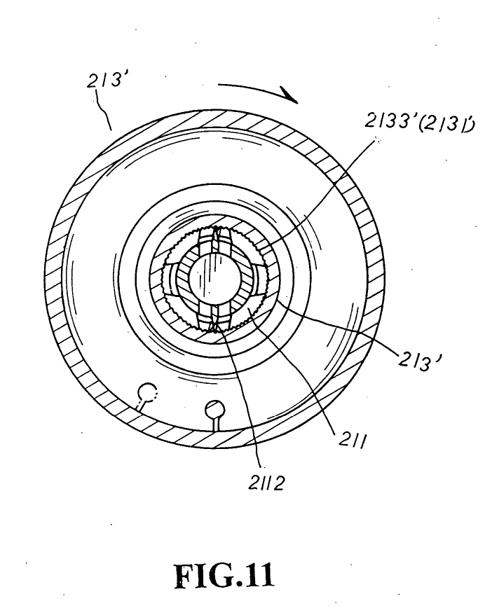

Thus, via the resilient ribs 2171, the stop blocks 2174, and the control sections 2172 of the switch device 217 correspondingly worked with the guide blocks 2154 of the adjusting seat 215, the sprinkler body is easily switched in angles, greatly reducing the torque force thereof and facilitating an easy and smooth operation thereof without the sprinkler body thereof being blocked or stopped even under low water pressure. Besides, the switching device 217 and the retaining pole 218 are separately designed. In case the sprinkler body of the sprinkler mount 20 is deliberately twisted and held to one side, the resilient ribs 2171 thereof will slip from the adjusting serrated section 2183 relative to the rotation of the retaining pole 218 and make the retaining pole 218 coupled with the gear-operated transmission mechanism 211 at one end spin vainly as shown in FIG. 10. Meanwhile, the resilient wing panels 2112 of the gear-operated transmission mechanism 211 will also spin vainly along the annular serrated facet 2133′ of the sleeve hole 2131′ thereof, providing a second layer of vain spinning for further protection. The design of the resilient wing panels 2112 also reduces the frictional area between the wing panels 2112 and the annular serrated facet 2133′ thereof so as to prolong the lifetime thereof. With respect to the sprinkler body's switch in angles, the control section 2172 of the switch device 217 can precisely move the flow switch plate 216 to accurately cover the previous upper and lower water orifices 2155, 2155′ for altering the angle of water discharge. Moreover, both ends of the flow switch plate 216 are abutted against the control sections 2172 of the switch device 217, preventing the flow switch plate 216 from being casually moved there-from so as to precisely switch the angle of the water discharge and effect the accurate operation of the sprinkling control unit 21 thereof. Finally, both the switch device 217 and the flow switch plate 21 share the same axis and are moved in the same direction, facilitating a more effortless and precise switch of water discharge even under lower water pressure.

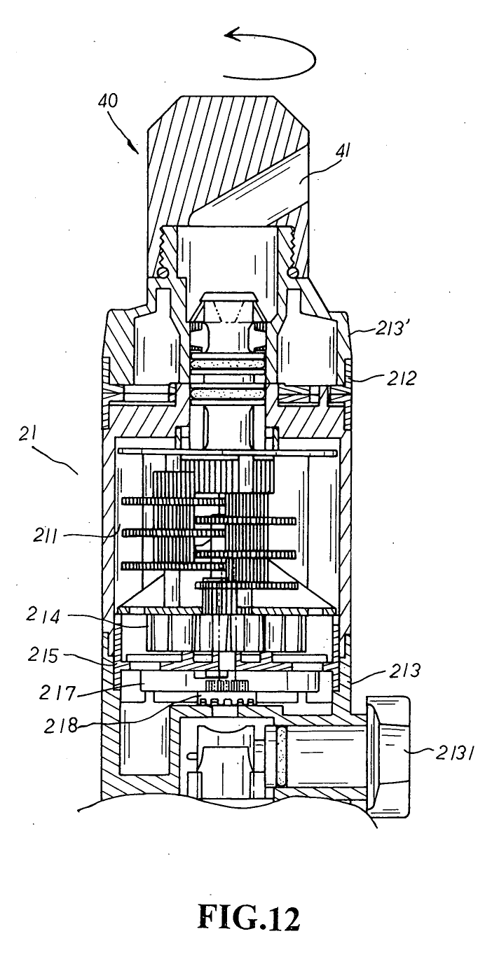

Please refer to FIG. 12 showing anther embodiment of the present invention. The sprinkling control unit can also be assembled into a vertical type. A sprinkler body 40 having a water nozzle 41 disposed thereon is mounted on top of the water outlet connector 213′ wherein the sprinkler body 40 is vertically swung back and forth relative to the sprinkling control unit 21 thereof.

1. A swinging mechanism for a lawn sprinkler, including a sprinkling control unit made up of a gear-operated transmission mechanism, a limiting connector, a water inlet connector, a water outlet connector, a main driving wheel, and an adjusting seat; the present invention being characterized by that,
a flow switch plate, a switch device, and a retaining pole being mounted to the side of the adjusting seat corresponding to the water inlet connector wherein the switch device, located to one end of the retaining pole, shares the same axis and is rotated in the same direction with the flow switch plate so as to precisely move the flow switch plate therewith for switching the angle of water discharge.

2. The swinging mechanism for a lawn sprinkler as claimed in claim I wherein the adjusting seat has a limiting groove indented at one side for the switch device to be adapted therein.

3. The swinging mechanism for a lawn sprinkler as claimed in claim II wherein the limiting groove of the adjusting seat thereof has a coupling rod with a pivoting hole disposed therein protruding at the center thereof for the flow switch plate to be joined thereto in sleeve engagement and the retaining pole to be led there-through at one end.

4. The swinging mechanism for a lawn sprinkler as claimed in claim II wherein the limiting groove of the adjusting seat thereof has protruded guide blocks, and symmetrical upper/lower water orifices properly disposed at preset areas thereon.

5. The swinging mechanism for a lawn sprinkler as claimed in claim I wherein the switch device is made of a frame body.

6. The swinging mechanism for a lawn sprinkler as claimed in claim V wherein the switch device has a plurality of resilient ribs extending centripetally at the inner side thereof, two indented control sections symmetrically cut at both arc lateral sides thereof, and a pair of inverted U-shaped resilient sections protruding at the inner upper and lower sides thereof.

7. The swinging mechanism for a lawn sprinkler as claimed in claim I wherein the retaining pole is made up of a pivoting rod with a squared coupling end disposed at one side, and an adjusting serrated section of larger diameter disposed at the other end thereof.

8. The swinging mechanism for a lawn sprinkler as claimed in claim VI wherein the resilient ribs of the switching device is abutted against the adjusting serrated section of the retaining pole by the ends in meshing location thereby.

9. The swinging mechanism for a lawn sprinkler as claimed in claim VI wherein the control sections of the switch device can precisely control the rotation and location of the flow switch plate thereof.

10. The swinging mechanism for a lawn sprinkler as claimed in claim VI wherein a stop block is protruded at the central top of the inverted U-shaped resilient section of the switch device thereof correspondingly matched and abutted against one side of the protruded guide block of the adjusting seat thereof.

11. The swinging mechanism for a lawn sprinkler as claimed in claim VII wherein the squared coupling end of the retaining pole is led through the pivoting hole of the adjusting seat to be inserted to a squared coupling hole disposed at one side of the gear-operated transmission mechanism thereof.

12. The swinging mechanism for a lawn sprinkler, including a sprinkling control unit made up of a gear-operated transmission mechanism, a limiting connector, a water inlet connector, a water outlet connector, a main driving wheel, and an adjusting seat with a flow switch plate, a switch device and a retaining pole adapted therein wherein a sprinkler body of various designs can be transversely mounted to one end of the water outlet connector thereof.

13. The swinging mechanism for a lawn sprinkler, including a sprinkling control unit made up of a gear-operated transmission mechanism, a limiting connector, a water inlet connector, a water outlet connector, a main driving wheel, and an adjusting seat with a flow switch plate, a switch device and a retaining pole adapted therein wherein the sprinkling control unit can also be assembled into a vertical type with a sprinkler body of various designs mounted on top of the water outlet connector thereof and swung vertically back and forth thereon.
